(19) United States
(12) Patent Application Publication
(10) Pub. No.: US 2009/0010183 A1
(43) Pub. Date: Jan. 8, 2009

(54) Function configuration method of electronic apparatuses

(75) Inventors: Cheng-Ru Lin, Taipei City (TW); Cheng-Yue Chang, Taipei (TW); Jeng-Chun Chen, Taipei City (TW)

Correspondence Address: BIRCH STEWART KOLASCH & BIRCH, PO BOX 747, FALLS CHURCH, VA, 22040-0747, US

(73) Assignee: Arcadyan Technology Corporation

(21) Appl. No.: 11/822,261

(22) Filed: Jul. 3, 2007

(51) Int. Cl. H04L 12/28

(52) U.S. Cl. 370/257

(57) ABSTRACT

A function configuration method according to the invention is cooperated with a master apparatus and a plurality of slave apparatuses. The function configuration method includes the steps of: assigning identification codes respectively to the slave apparatus by the master apparatus; transmitting the identification codes to the corresponding slave apparatuses through a network; and setting function configurations of the slave apparatuses according to the identification codes in the master apparatus.

### BACKGROUND OF THE INVENTION

1. Field of Invention

The invention relates to a function configuration method and, in particular, to a function configuration method of electronic apparatuses.

2. Related Art

By the improvement of technology, a variety of electronic apparatuses are developed. In particular, the electronic apparatuses used to play media data, such as DVD players, speakers or LCDs, etc., are indispensable in our daily life.

Users can utilize these electronic apparatuses to build a media playing environment at home. For example, an LCD is firstly set up and two speakers are disposed aside the LCD. Then, a DVD player is installed to serve as a media data source. In the prior art, the DVD player is connected to the speakers and LCD by audio-video (AV) cables, so that the speakers can play audio data and the LCD can display video data. Therefore, users can enjoy the media environment constructed by the electronic apparatuses.

Recently, due to the widespread applications of networks, the concepts and technologies of digital home are also utilized in conjunction with the multimedia. Accordingly, multimedia apparatuses are capable of transmitting data through network lines.

However, using network lines for transmitting data to media apparatuses always leads to the function configuration problem. For example, if the audio data is transmitted to a speaker through a network line, the speaker may not tell which part of the audio data must be played, resulting in playing errors. In addition, regarding to a screen wall composed of a plurality of display apparatuses, each display apparatus can not precisely determine which part of the transmitted video data must be played.

Therefore, it is an important subject to provide a function configuration method, which can configure electronic apparatuses dynamically to enhance the AV playing efficiency.

### SUMMARY OF THE INVENTION

In view of foregoing, the invention is to provide a function configuration method that can configure electronic apparatuses dynamically to enhance the AV playing efficiency.

To achieve the above, a function configuration method according to the invention is cooperated with a master apparatus and a plurality of slave apparatuses. The function configuration method includes the steps of: assigning identification codes respectively to the slave apparatus by the master apparatus; transmitting the identification codes to the corresponding slave apparatuses through a network; and setting function configurations of the slave apparatuses according to the identification codes in the master apparatus.

As mentioned above, the function configuration method of the invention is to assign identification codes respectively to the slave apparatuses by the master apparatus and transmit identification codes to the corresponding slave apparatuses through a network. After knowing the identification codes of the slave apparatuses, the user can implement function configurations in the master apparatus according to the identification codes for the slave apparatuses. Therefore, each slave apparatus can be configured to have an individual playing function so as to enhance the AV playing efficiency.

### BRIEF DESCRIPTION OF THE DRAWINGS

The invention will become more fully understood from the detailed description given herein below illustration only, and thus is not limitative of the present invention, and wherein:

FIG. 1 is a schematic view of electronic apparatuses utilized in a function configuration method according to a preferred embodiment of the invention, wherein the slave apparatuses are speakers;

FIG. 2 is a flowchart of the function configuration method according to the preferred embodiment of the invention;

FIG. 3 is a schematic view of electronic apparatuses utilized in a function configuration method according to a preferred embodiment of the invention, wherein the slave apparatuses are being a screen wall; and

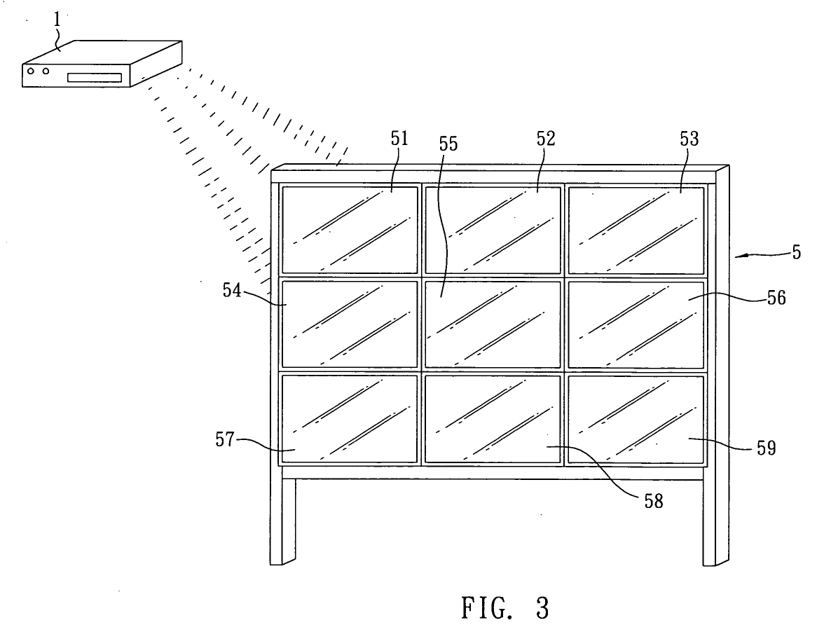

FIG. 4 is a schematic view of electronic apparatuses utilized in a function configuration method according to a preferred embodiment of the invention, wherein the slave apparatuses are speakers and a screen wall.

### DETAILED DESCRIPTION OF THE INVENTION

The present invention will be apparent from the following detailed description, which proceeds with reference to the accompanying drawings, wherein the same references relate to the same elements.

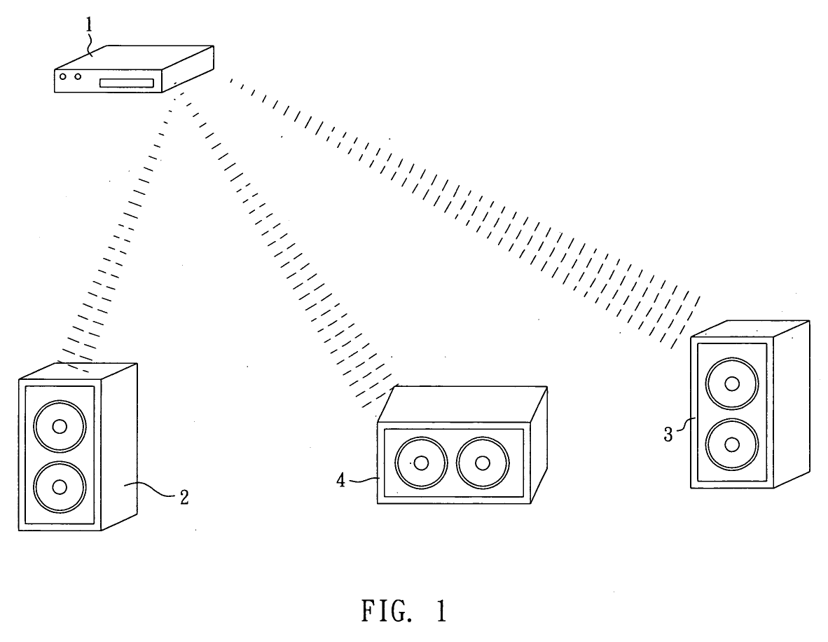

As shown in FIG. 1, a function configuration method according to a preferred embodiment of the invention is cooperated with a master apparatus and a plurality of slave apparatuses. The master apparatus and the slave apparatuses are all electronic apparatuses. The maser apparatus provides data for playing, and the slave apparatuses receive and play the data. In the embodiment, the maser apparatus can be a terminal apparatus (such as a computer) or a media source apparatus (such as a DVD player). The slave apparatus can be a media playing apparatus, such as a flat panel device (FPD), a speaker or a screen wall. In the embodiment, the master apparatus is a DVD player 1, the slave apparatuses are three speakers 2 to 4, for example.

In the embodiment, the DVD player 1 and the speakers 2 to 4 are connected to build a network. The network can be a wired network or a wireless network. Signals are transmitted in the wired network by network lines, and signals are transmitted in the wireless network by a wireless communication technology, such as Bluetooth or Wi-Fi. The network of the embodiment is a wireless network for example.

When the user wants to build a media playing environment including the DVD player 1 and the speakers 2 to 4, the function configurations thereof must be finished in advance to set playing functions. For example, the speakers 2 to 4 are configured to play audio data of different channels.

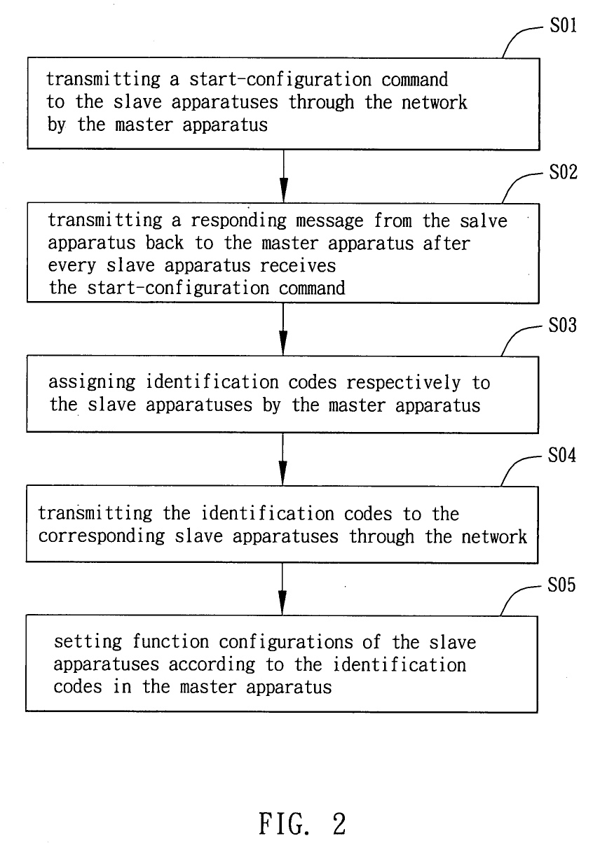

As shown in FIG. 2, the function configuration method according to the embodiment of the invention includes steps S01 to S05. Firstly, in step S01, the master apparatus transmits a start-configuration command to the slave apparatuses through the network. In the embodiment, the DVD player 1 transmits the start-configuration command to a broadcast channel so that the speakers 2 to 4 receive the start-configuration command. When the speakers 2 to 4 receive the start-configuration command, they will prepare to start the function configurations.

Step S02 is to transmit a responding message from the slave apparatus back to the master apparatus after each slave apparatus receives the start-configuration command so as to inform the master apparatus that the slave apparatus has been ready to start the function configuration. In the embodiment, after receiving the start-configuration command, the speakers 2 to 4 transmit responding messages to the DVD player 1.

In step S03, the master apparatus assigns identification codes respectively to the slave apparatuses. In the embodiment, the DVD player 1 assigns identification codes respectively to the speakers 2 to 4. The format of the identification codes is, for example but not limited to, a numeral format.

Step S04 is to transmit the identification codes to the corresponding slave apparatuses through the network. In the embodiment, the DVD player 1 encloses the identification codes regarding to the speakers 2 to 4 into the identification messages, and then transmits the identification messages to the speakers 2 to 4, respectively. Therefore, the speakers 2 to 4 can receive the corresponding identification codes. In the embodiment, when the speakers 2 to 4 get the corresponding identification codes, they show the identification codes with utilizing a broadcasting method. Thus, the user can know the identification codes of the speakers 2 to 4.

Step S05 is to set function configurations of the slave apparatuses according to the identification codes in the master apparatus. In the embodiment, the user sets function configurations of the speakers 2 to 4 according to their identification codes in the master apparatus. That is, the user can determine the roles of the speakers 2 to 4 in the media playing environment. For example, the speaker 2 is configured to be a left channel speaker, the speaker 3 is configured to be a right channel speaker and the speaker 4 is configured to be a center speaker. Therefore, the speakers 2 to 4 can be well configured with their corresponding roles and playing functions. The DVD player 1 can transmit data packets to the speakers 2 to 4 according to the corresponding function configurations, so that the speakers 2 to 4 can play the corresponding data. The data packets include an audio data. Therefore, the function configurations of the slave apparatuses are completed.

Of course, the slave apparatuses of the embodiment are not limited to the speakers, and can be other media source apparatuses, such as flat panel devices (FPDs) or a screen wall. As shown in FIG. 5, the slave apparatuses are being a screen wall 5. The screen wall 5 is composed of nine display apparatuses 51 to 59 and each of the display apparatuses 51 to 59 is a slave apparatus. For this case, the foregoing function configuration method can continue to be utilized; nevertheless, the speakers 2 to 4 are for playing audio data and the display apparatuses 51 to 59 are for displaying video data.

Besides, after the display apparatuses 51 to 59 receive the identification codes in the step S04, they show their own identification codes with utilizing a displaying method. Therefore, users can know the identification codes of the display apparatuses 51 to 59. Additionally, when the user determine the roles of the display apparatuses 51 to 59 in the step S05, the display apparatus 51 can be configured to be situated at the position (1, 1) of the screen wall 5, the display apparatus 52 can be configured to be situated at the position (1, 2) of the screen wall 5, etc. Thus, the display apparatuses 51 to 59 can be well configured with their corresponding roles and playing functions. The DVD player 1 can transmit data packets to the display apparatuses 51 to 59 according to the corresponding function configurations, so that the display apparatuses 51 to 59 can play the data respectively.

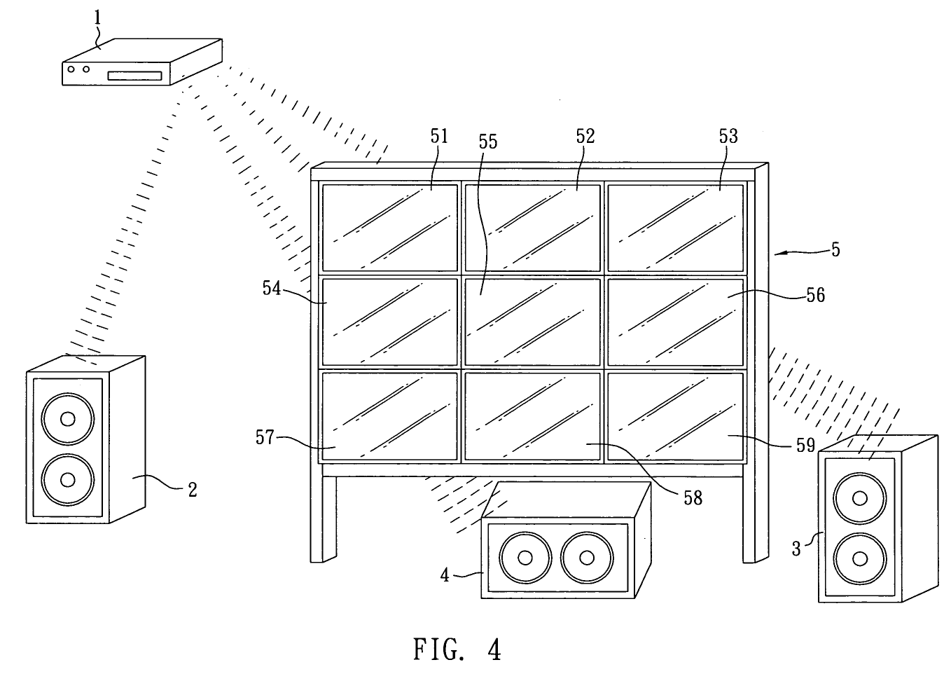

Moreover, the function configuration method of the embodiment can be applied to the slaves which are the speakers 2 to 4 and the display apparatuses 51 to 59 simultaneously, as shown in FIG. 4. For the method is expatiated in the former embodiment, it is not given unnecessary details any more here.

As mentioned above, the function configuration method of the invention is to assign identification codes respectively to the slave apparatuses by the master apparatus and transmit identification codes to the corresponding slave apparatuses through a network. After knowing the identification codes of the slave apparatuses, the user can implement function configurations in the master apparatus according to the identification codes for the slave apparatuses. Therefore, each slave apparatus can be configured to have an individual playing function so as to enhance the AV playing efficiency.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. A function configuration method cooperated with a master apparatus and a plurality of slave apparatuses, comprising:
assigning identification codes respectively to the slave apparatuses by the master apparatus;
transmitting the identification codes to the corresponding slave apparatuses through a network; and
setting function configurations of the slave apparatuses according to the identification codes in the master apparatus.

2. The function configuration method as recited in claim 1, before assigning the identification code, further comprising:
transmitting a start-configuration command to the slave apparatuses through the network by the master apparatus; and
transmitting a responding message from the slave apparatus back to the master apparatus after the slave apparatus receives the start-configuration command.

3. The function configuration method as recited in claim 1, after the slave apparatus receives the identification code, further comprising:
showing the identification code by the slave apparatus with utilizing a displaying method or a broadcasting method.

4. The function configuration method as recited in claim 1, further comprising:
transmitting data packets to the corresponding slave apparatuses by the master apparatus according to the corresponding function configurations.

5. The function configuration method as recited in claim 4, wherein the data packet comprises a video data, an audio data or an audio-video (AV) data.

6. The function configuration method as recited in claim 1, wherein the network is a wired network or a wireless network.

7. The function configuration method as recited in claim 1, wherein the master apparatus is a terminal apparatus or a media source apparatus.

8. The function configuration method as recited in claim 7, wherein the media source apparatus is a computer or a DVD player.

9. The function configuration method as recited in claim 1, wherein the slave apparatus is a media playing apparatus.

10. The function configuration method as recited in claim 9, wherein the media playing apparatus is a flat panel display (FPD) apparatus, a speaker or a portion of a screen wall.
